(19) United States
(12) Patent Application Publication
(10) Pub. No.: US 2011/0045375 A1
(43) Pub. Date: Feb. 24, 2011

(54) FUEL CELL UNIT, FUEL CELL STACK, AND ELECTRONIC DEVICE

(75) Inventors: Kengo Makita, Kanagawa (JP); Shinichi Uesaka, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/933,272

(22) PCT Filed: Mar. 19, 2009
(86) PCT No.: PCT/JP2009/055411

§ 371 Date: Sep. 17, 2010

(30) Foreign Application Priority Data
Mar. 24, 2008 (JP) P2008-076280

(51) Int. Cl. H01M 8/24; H01M 8/10

(52) U.S. Cl. 429/455; 429/452; 429/479

(57) ABSTRACT

In a fuel cell unit, oxygen electrodes are disposed on both face sides of a fuel electrode. The fuel electrode has a diffusion layer and a catalyst layer on both faces of a current collector, and each of the oxygen electrodes has a diffusion layer and a catalyst layer on the faces opposed to the fuel electrode of the current collector. A fuel/electrolyte channel for passing a fluid containing a fuel and an electrolyte is provided between the fuel electrode and each of the oxygen electrodes. The fuel and the electrolyte are supplied to both faces of the one fuel electrode, so that a reaction occurs and power is obtained between the fuel electrode and each of the oxygen electrodes.

### CROSS REFERENCE TO RELATED APPLICATIONS

The present application is a National Stage of International Application No. PCT/JP2009/055411 filed on Mar. 19, 2009 and which claims priority to Japanese Patent Application No. 2008-076280 filed on Mar. 24, 2008, the entire contents of which are being incorporated herein by reference.

### BACKGROUND

The present disclosure relates to a fuel cell unit such as a direct methanol fuel cell (DMFC) in which methanol is directly supplied to a fuel electrode to cause a reaction, a fuel cell stack, and an electronic device having them.

Indexes of characteristics of a cell include energy density and power density. The energy density denotes an energy accumulation amount per unit mass of a cell, and the power density denotes an output amount per unit mass of a cell. A lithium-ion secondary cell has two characteristics of relatively high energy density and extremely high power density. Since the degree of perfection of a lithium-ion secondary cell is high, the cell is widely employed as a power source of a mobile device. However, in recent years, as the performance of a mobile device is becoming higher, the power consumption of the mobile device tends to increase. The lithium-ion secondary cell is requested to further improve its energy density and power density.

Solutions for the improvement include a change in electrode materials of a cathode and an anode, improvement in a method of applying an electrode material, and improvement in a method of sealing the electrode material, and studies to improve the energy density of a lithium-ion secondary cell are being conducted. However, hurdles for practical use are still high. In addition, as long as the materials used for a lithium-ion secondary cell at present are not changed, it is difficult to expect large improvement in the energy density.

Consequently, it is urgent to develop a cell having higher energy density, replacing the lithium-ion secondary cell, and a fuel cell is promising as one of candidates.

A fuel cell has a configuration that electrolyte is disposed between an anode (fuel electrode) and a cathode (oxygen electrode). Fuel is supplied to the fuel electrode, and air or oxygen is supplied to the oxygen electrode. As a result, an oxidation-reduction reaction in which the fuel is oxidized by oxygen in the fuel and oxygen electrodes occurs, and a part of chemical energy of the fuel is converted to electrical energy and taken out.

Various kinds of fuel cells have been proposed or formed as prototypes and a part of them is practically used. Those fuel cells are classified into, according to electrolytes used, an alkaline fuel cell (AFC), a phosphoric acid fuel cell (PAFC), a molten carbonate fuel cell (MCFC), a solid electrolyte fuel cell (SOFC), and a polymer electrolyte fuel cell (PEFC). The PEFC may operate at a lower temperature as compared with other types, for example, at a temperature of about 30° C. to 130° C.

As the fuels of fuel cells, various combustible materials such as hydrogen and methanol may be used. However, a gas fuel such as hydrogen is not suitable for miniaturization for a reason that a bottle for storage or the like is necessary. On the other hand, a liquid fuel such as methanol is advantageous with respect to the point that it is easily stored. In particular, the DMFC does not need a reformer for taking out hydrogen from a fuel, has a simple configuration, and has an advantage that miniaturization is easy.

In a DMFC, methanol as the fuel is usually supplied as a solution of low or high concentration or in a state of gas of pure methanol to the fuel electrode, and is oxidized to carbon dioxide by a catalyst layer of the fuel electrode. Protons generated at this time move to the oxide electrode through an electrolyte film that separates the fuel electrode and the oxygen electrode and react with oxygen in the oxygen electrode to generate water. The reactions which occur in the fuel electrode, the oxygen electrode, and the entire DMFC are expressed by chemical formula (1).

Fuel electrode:CH₃OH+H₂O→CO₂+6e⁻+6H⁺

Oxygen electrode:(3/2)O₂+6e⁻+6H⁺→3H₂O

Entire DMFC:CH₃OH+(3/2)O₂→CO₂+2H₂O (Chemical Formula 1)

The energy density of methanol as the fuel of the DMFC is theoretically 4.8 kW/L and is equal to or higher than ten times as high as energy density of a general lithium-ion secondary cell. That is, there is much possibility that the energy density of a fuel cell using methanol as the fuel exceeds that of a lithium-ion secondary cell. Consequently, the possibility that the DMFC is used as the energy source of a mobile device, an electric car, or the like is the highest among various fuel cells.

However, the DMFC has an issue such that the output voltage when power is actually generated drops to about 0.6V or less regardless of the fact that the theoretical voltage is 1.23V. The cause of the drop in the output voltage is a voltage drop caused by internal resistance of the DMFC. The DMFC has resistance accompanying a reaction occurring across the electrodes, resistance accompanying movement of the substances, resistance occurring when the protons move through the electrolyte film and, further, internal resistance such as contact resistance. Since energy which is actually extracted as the electrical energy from oxidization of methanol is expressed by a product of the output voltage at the time of power generation and the amount of electricity flowing in the circuit, when the output voltage at the time of power generation drops, the energy which can be actually extracted decreases by the amount. The amount of electricity which can be taken out to the circuit by oxidation of methanol is proportional to the amount of methanol in the DMFC when the entire amount of methanol is oxidized in the fuel electrode according to the chemical formula (1).

Further, the DMFC also has an issue of methanol cross-over. The methanol cross-over is a phenomenon that methanol passes through an electrolyte membrane from a fuel electrode side and reaches an oxygen electrode side by two mechanisms of a phenomenon that methanol diffuses and moves due to the density difference of methanol between the fuel electrode side and the oxygen electrode side and an electroosmotic phenomenon that hydrated methanol is carried by movement of water caused in association with movement of protons.

When the methanol cross-over occurs, the passed methanol is oxidized by the catalyst layer in the oxygen electrode. The methanol oxidation reaction on the oxygen electrode side is the same as the oxidation reaction on the fuel electrode side and it may cause drop in the output voltage of the DMFC. Since methanol is not used for power generation on the fuel electrode side but is consumed on the oxygen electrode side, the amount of electricity taken out to the circuit decreases by the amount. Further, since the catalyst layer in the oxygen electrode is not a platinum (Pt)-ruthenium (Ru) alloy catalyst but is a platinum (Pt) catalyst, carbon monoxide (CO) is easily adsorbed on the surface of the catalyst, and there is also an inconvenience that poisoning of the catalyst occurs.

As described above, the DMFC has the two issues of the voltage drop caused by the internal resistance and the methanol cross-over and waste of the fuel due to the methanol cross-over. The issues cause decrease in the power generation efficiency of the DMFC. Consequently, to increase the power generation efficiency of the DMFC, research and development to improve the characteristics of the materials of the DMFC and research and development to optimize the operation conditions of the DMFC are being carried out energetically.

The studies to improve the characteristics of the materials constructing the DMFC include a study regarding catalysts on the electrolyte membrane and the fuel electrode side. As the electrolyte membrane, presently, a polyperfuluoroalkyl sulfonic acid-based resin film (“Nafion” (registered trademark) made by DuPont) is generally used. As electrolyte membranes having higher proton conductance and higher methanol permeation preventing performance, a fluorine-based polymer membrane, a hydrocarbon polymer electrolyte membrane, a hydrogel electrolyte membrane, and the like are being examined. As for the catalyst on the fuel electrode side, a catalyst which is activated higher than a platinum (Pt)-ruthenium (Ru) alloy catalyst generally used at present is being researched and developed.

Improvement in the characteristics of the materials of a fuel cell is proper as means to improve the power generation efficiency of the fuel cell. In the present circumstances, however, optimum electrolyte membranes as well as optimum catalysts which address the above-described two issues have not been found.

On the other hand, patent document 1 discloses a method of using a liquid electrolyte (electrolytic solution) in place of an electrolyte membrane. In some cases, the electrolytic solution remains stationary between the oxygen electrode and the fuel electrode. There is also a case that the electrolytic solution flows in a channel provided between the oxygen electrode and the fuel electrode, goes to the outside, after that, returns in the channel, and circulates.

Patent document 1: Japanese Unexamined Patent Application Publication No. Sho 59-191265

### SUMMARY

Further, in a fuel cell, the power taken out from a single fuel cell is extremely low. To take out a practical current, a plurality of fuel cells have to be stacked and connected in series.

A general method of connecting fuel cells is a so-called monopolar method of connecting an end of the oxygen electrode to the fuel electrode in an adjacent cell via a wire. However, according to the monopolar method, since the structure is that a plurality of fuel cells are simply stacked, the thickness of the entire fuel cell stack increases only by the number of fuel cells stacked. There is consequently an issue such that the thickness of the entire cell increases inevitably and the size becomes bigger.

In addition, there is also a method of connecting the entire surface of the fuel electrode and the oxygen electrode of an adjacent cell while integrating them using a bipolar plate. However, in the case of using such a bipolar plate, the thickness of the entire stack depends on the thickness of the bipolar plate. Usually, channels and the like for the fuel electrode and the oxygen electrode have to be formed in the bipolar plate, it is difficult to largely reduce the thickness of the bipolar plate.

In view of the foregoing, it is desirable to provide a fuel cell unit, a fuel cell stack, and an electronic device having the same realizing suppressed increase in thickness in the case of stacking a plurality of fuel cells.

A fuel cell unit according to an embodiment includes: a fuel electrode having opposed two faces; first and second oxygen electrodes provided so as to face the both faces of the fuel electrode; and an electrolyte layer provided between the fuel electrode and each of the first and second oxygen electrodes.

A fuel cell stack according to the embodiment is obtained by stacking a plurality of the fuel cell units of the invention. An electronic device according to the invention is obtained by mounting the fuel cell unit of the invention.

In the fuel cell unit, the fuel cell stack, and the electronic device of the embodiment, by providing first and second oxygen electrodes on both sides of a fuel electrode in the fuel cell unit, the reactive area in the fuel electrode enlarges.

In the fuel cell unit of the embodiment, preferably, a channel for flowing a first fluid containing a fuel and an electrolyte is provided on the fuel electrode side of each of the first and second oxygen electrodes. With the configuration, as compared with the case where a channel for flowing a fuel and a channel for flowing an electrolytic solution are provided separately, reduction in thickness is realized more easily.

In the fuel cell stack according to the embodiment, preferably, the first or second oxygen electrode of one fuel cell unit and the first or second oxygen electrode of other fuel cell unit are connected so as to face each other, and a channel for flowing a second fluid is commonly used by the one fuel cell unit and the other fuel cell unit in the connection part. With the configuration, increase in the thickness caused by layer stacking can be suppressed more effectively.

In the fuel cell unit and the fuel cell stack of the embodiment, first and second oxygen electrodes are provided on both sides of the fuel electrode, so that the reactive area of the fuel electrode is enlarged. With the structure of disposing one fuel electrode for two oxygen electrodes, power almost equivalent to that of two fuel cells is obtainable. Therefore, in the case of stacking a plurality of fuel cells, increase in thickness is suppressed. In addition, the embodiment is suitably used for a thin power-consuming electronic device.

Additional features and advantages are described herein, and will be apparent from, the following Detailed Description and the figures.

### BRIEF DESCRIPTION OF THE FIGURES

FIG. 1 is a cross section illustrating a general configuration of a fuel cell unit according to a first embodiment.

FIG. 2 is a diagram illustrating the configuration of a fuel cell according to a comparative example.

FIG. 3 is a diagram for explaining the characteristics of the fuel cell illustrated in FIG. 1.

FIG. 4 is a diagram illustrating a schematic configuration of an electronic device having the fuel cell unit shown in FIG. 1.

FIG. 5 is a diagram illustrating a modification of the fuel cell illustrated in FIG. 1.

FIG. 6 is a cross section illustrating a schematic configuration of a fuel cell unit according to a second embodiment.

### DETAILED DESCRIPTION

Embodiments will be described in detail below with reference to the drawings.

### First Embodiment

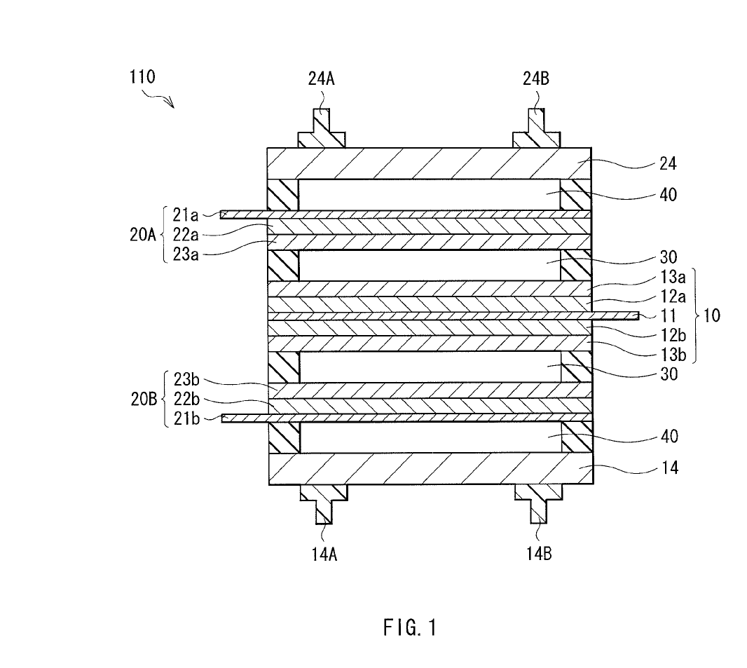

FIG. 1 illustrates a sectional structure of a fuel cell unit 110 according to a first embodiment. The fuel cell unit 110 is a so-called direct methanol flow based fuel cell (DMFFC) in which two oxygen electrodes (cathodes) 20A and 20B are provided with one fuel electrode (anode) 10 therebetween in exterior members 14 and 24. That is, the oxygen electrodes 20A and 20B are disposed so as to be opposed to each other on both faces of the fuel electrode 10.

The fuel electrode 10 has a configuration that a diffusion layer 12a and a catalyst layer 13a are stacked on one face side and a diffusion layer 12b and a catalyst layer 13b are stacked on the other face side using a current collector 11 as a center. The oxygen electrode 20A has a configuration that a diffusion layer 22a and a catalyst layer 23a are stacked in order on a side opposite to the fuel electrode 10 of a current collector 21a, and the oxygen electrode 20B has a configuration that a diffusion layer 22b and a catalyst layer 23b are stacked in order on a side opposite to the fuel electrode 10 of a current collector 21b.

The current collector 11 is made of, for example, a porous member or a plate member having electric conductivity, concretely, titanium (Ti) mesh, a titanium plate, or the like. The current collectors 21a and 21b are made of, for example, titanium mesh.

The diffusion layers 12a, 12b, 22a, and 22b are made by, for example, carbon cloth, carbon paper, or a carbon sheet. Desirably, the diffusion layers 12a, 12b, 22a, and 22b are subjected to water repellent process by polytetrafluoroethylene (PTFE) or the like. However, the diffusion layers 12a, 12b, 22a, and 22b are not necessarily provided. A catalyst layer may be formed directly on the current collector.

The catalyst layers 13a, 13b, 23a, and 23b are constructed by, as a catalyst, for example, a metal itself or an alloy of palladium (Pd), platinum (Pt), iridium (Ir), rhodium (Rh), ruthenium (Ru), or the like, an organic complex, enzyme, or the like. In addition, the catalyst layers 13a, 13b, 23a, and 23b may include a proton conductor and a binder in addition to the catalyst. Examples of the proton conductor include a polyperfuluoroalkyl sulfonic acid-based resin (“Nafion” (registered trademark) made by DuPont) and a resin having proton conductivity. The binder is added to maintain strength and flexibility of the catalyst layers 13a, 13b, 23a, and 23b and is, for example, a resin such as polytetrafluoroethylene (PTFE), polyvinylidene fluoride (PVDF) or the like. As such catalyst layers 13a, 13b, 23a, and 23b, it is desirable to use a selective catalyst which does not oxidize the fuel flowing in a fuel/electrolyte channel 30, for example, palladium, a palladium alloy (including a binary alloy, a ternary alloy, a quarternary alloy, and the like) such as palladium iron, palladium cobalt, palladium nickel, or palladium chromium, or a ruthenium alloy such as RuSe.

The fuel/electrolyte channel 30 for flowing a fluid (first fluid) F1 containing a fuel and an electrolyte is provided between the fuel electrode 10 and the oxygen electrode 20A and between the fuel electrode 10 and the oxygen electrode 20B. On the other hand, on the outside of the oxygen electrodes 20A and 20B, an air channel 40 for supplying air or oxygen (second fluid) is provided.

The fuel/electrolyte channel 30 is obtained by forming a fine channel by, for example, processing a resin sheet, and is adhered to both face sides of the fuel electrode 10. To the fuel/electrolyte channel 30, the fluid F1 containing the fuel and the electrolyte such as a methanol sulfuric acid mixture is supplied via a fuel/electrolyte inlet port 14A and a fuel/electrolyte outlet port 14B provided for the exterior member 14. The number of channels is not limited. Besides, the shape of the channel is, for example, a snake shape or a parallel shape and is not limited. Further, the width, height, and length of the channel are not also limited but are preferably small. Furthermore, the fluid F1 may be flown in a state where the fuel and the electrolyte are mixed or in a state where the fuel and the electrolytic solution are isolated.

To the air channel 40, air is supplied via an air inlet port 24A and an air outlet port 24B provided for the exterior member 24 by natural ventilation or a forced supplying method using a fan, a pump, a blower, or the like.

Each of the exterior members 14 and 24 has, for example, a thickness of 1 mm and is made of a generally available material such as a titanium (Ti) plate. The material is not limited. The thinner the exterior members 14 and 24 is, the more it is preferable.

For example, the above-described fuel cell unit 110 may be manufactured as follows.

First, the fuel electrode 10 is formed. As a catalyst, the catalyst layers 13a and 13b are formed by, for example, mixing an alloy containing platinum and ruthenium at predetermined ratios and a disperse solution of the polyperfuluoroalkyl sulfonic acid-based resin (“Nafion” (registered trademark) made by DuPont) at predetermined ratios. The catalyst layers 13a and 13b are thermocompression-bonded on the diffusion layers 12a and 12b made of the above-described material, respectively. Subsequently, the diffusion layer 12a and the catalyst layer 13a are thermocompression-bonded on one face of the current collector 11 made of the above-described material and the diffusion layer 12b and the catalyst layer 13b are thermocompression-bonded on the other face by using a hot-melt adhesive or an adhesive resin sheet. In such a manner, the fuel electrode 10 is formed. Alternatively, without forming the diffusion layers 12a and 12b, the catalyst layers 13a and 13b may be formed directly on both sides of the current collector 11 as mentioned above.

On the other hand, the oxygen electrodes 20A and 20B are formed. First, as a catalyst, carbon carrying platinum and the disperse solution of the polyperfuluoroalkyl sulfonic acid-based resin (“Nafion” (registered trademark) made by DuPont) are mixed at predetermined ratios to form the catalyst layers 23a and 23b. The catalyst layers 23a and 23b are thermocompression-bonded on the diffusion layers 22a and 22b made of the above-described material, respectively. Subsequently, the diffusion layer 22a and the catalyst layer 23a are thermocompression-bonded on the current collector 21a made of the above-described material and the diffusion layer 22b and the catalyst layer 23b are thermocompression-bonded on the current collector 21b by using a hot-melt adhesive or an adhesive resin sheet. In such a manner, the oxygen electrodes 20A and 20B are formed.

On the other hand, an adhesive resin sheet is prepared. By forming a channel in the resin sheet, the fuel/electrolyte channel 30 is formed. The exterior member 14 made of the above-described material is provided with, for example, the fuel/electrolyte input port 14A and the fuel/electrolyte output port 14B made by resin joints. The exterior member 24 is provided with, for example, the air inlet port 24A and the air outlet port 24B made by resin joints.

Subsequently, the fuel/electrolyte channels 30 are thermocompression-bonded to both sides of the fuel electrode 10.

Finally, the two oxygen electrodes 20A and 20B are bonded to both faces of the thermocompression-bonded fuel/electrolyte channels 30 so as to sandwich them, and are housed in the exterior members 14 and 24. In such a manner, the fuel cell unit 110 illustrated in FIG. 1 is completed.

Next, the action and effects of the fuel cell unit 110 will be described.

In the fuel cell unit 110, when the fuel and the electrolyte are supplied via the fuel/electrolyte channels 30 to the fuel electrode 10, protons and electrons are generated by a reaction. The protons move to the oxygen electrodes 20A and 20B via the fuel/electrolyte channels 30 and react with the electrons and oxygen to generate water. The reaction which occurs in the fuel electrode 10, the oxygen electrode 20, and the fuel cell unit 110 as a whole is expressed by chemical formula 2. A part of chemical energy of methanol as the fuel is converted to electrical energy and taken out as power. Carbon dioxide generated in the fuel electrode 10 and water generated in the oxygen electrodes 20A and 20B flow out to the fuel/electrolyte channels 30 and removed.

Fuel electrode 10:CH₃OH+H₂O→CO₂+6e⁻+6H⁺

Oxygen electrode 20:(3/2)O₂+6e⁻+6H⁺→3H₂O

Entire fuel cell unit 110:CH₃OH+(3/2)O₂→CO₂+2H₂O (Chemical Formula 2)

In particular, the oxygen electrodes 20A and 20B are disposed on both faces of the fuel electrode 10 so as to be opposed to each other, and the fuel and electrolyte are supplied to both faces of the fuel electrode 10, thereby enlarging a reactive area without increasing the thickness of the fuel electrode 10. By electrically connecting the two oxygen electrodes 20A and 20B, an output of the fuel cell unit 110 becomes almost equivalent to that in the case of connecting two fuel cells (unit cells) each obtained by a combination of one fuel electrode and one oxygen electrode.

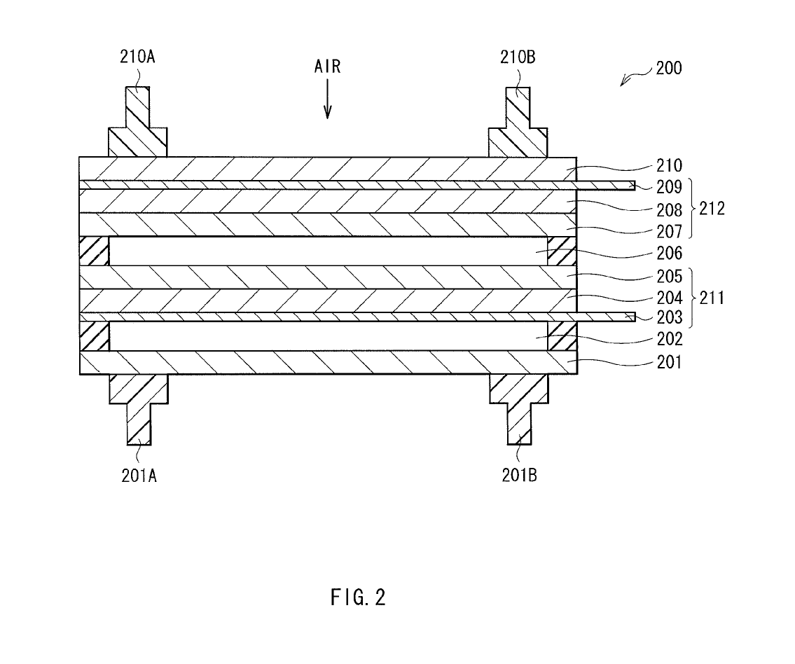

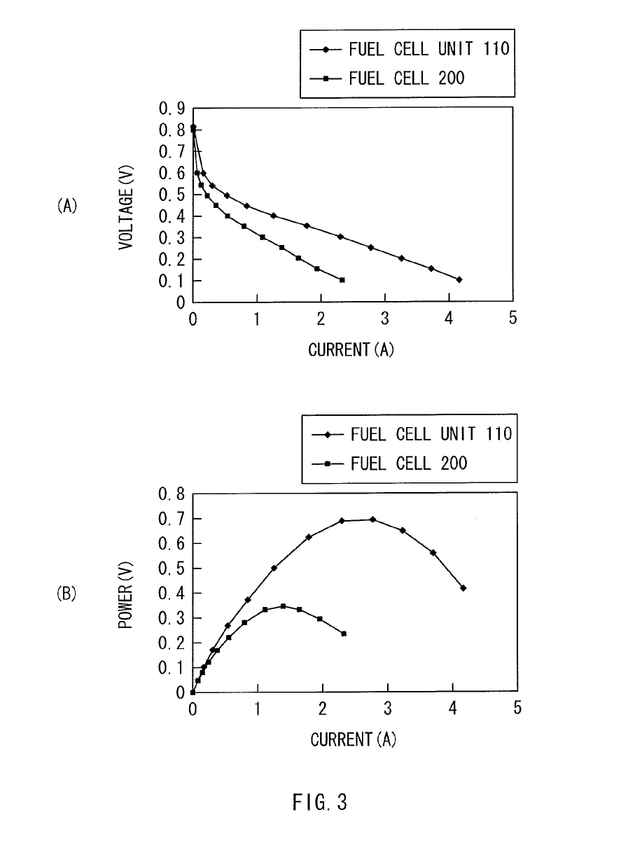

FIG. 2 shows a sectional structure of a fuel cell 200 obtained by housing one fuel electrode 211 and one oxygen electrode 212 in exterior members 201 and 210. The fuel electrode 211 is obtained by stacking a diffusion layer 204 and a catalyst layer 205 on a current collector 203, and the oxygen electrode 212 is obtained by stacking a diffusion layer 208 and a catalyst layer 207 on a current collector 209. The catalyst layers 205 and 207 are disposed so as to be opposed to each other. An electrolytic solution channel 206 for flowing electrolytic solution is provided between the fuel electrode 211 and the oxygen electrode 212, and a fuel channel 202 for supplying fuel is provided between the fuel electrode 211 and the exterior member 201. The exterior member 201 has a fuel inlet port 201A and a fuel outlet port 201B, and the exterior member 210 has an electrolytic solution inlet port 210A and an electrolytic solution outlet port 210B. FIG. 3(A) illustrates the current-voltage characteristic of such a fuel cell 200 and the fuel cell unit 1 of the embodiment, and FIG. 3(B) illustrates the current-power characteristic.

As illustrated in FIGS. 3(A) and (B), the voltage-current characteristic and the power-current characteristic of the fuel cell unit 110 of the embodiment are improved as compared with those of the fuel cell 200 in which one fuel electrode and one oxygen electrode are disposed so as to be opposed to each other. In particular, it is understood that as the current increases, the difference between them increases, and the fuel cell unit 110 realizes the voltage and power which is twice or more as large as those of the fuel cell 200. In addition, the reason why the voltage and power becomes twice or more is considered that heat is filled in the fuel cell unit 110 by the stacking, the temperature rises, and the catalytic reaction is promoted.

As described above, in the fuel cell unit 110 of the embodiment, the oxygen electrodes 20A and 20B are provided on both sides of the fuel electrode 10, so that the reactive area of the fuel electrode 10 is enlarged. By the structure of disposing one fuel electrode for two oxygen electrodes, the power almost equivalent to that of two fuel cells is obtainable. Therefore, at the time of stacking a plurality of fuel cells, increase in the thickness is suppressed.

Further, with the fuel/electrolyte channel 30, the fuel and the electrolyte are flown in the same channel, and the fuel and the electrolyte are supplied by one channel. As compared with the case of flowing the fuel and the electrolyte in different channels, the structure is simpler, and reduction in thickness is realized more easily. Further, by supplying the fuel and the electrolyte as fluids, an electrolyte membrane becomes unnecessary. Therefore, power is generated without being influenced by temperature and humidity. As compared with the case of using an electrolyte membrane, ion conductivity (proton conductivity) is made higher. There is no possibility of degradation in the electrolyte membrane and decrease in the proton conductivity due to drying of the electrolyte membrane, so that issues of flooding, moisture management, and the like in the oxygen electrode are solved.

### Application Example

Next, an application example of the fuel cell unit of the embodiment will be described.

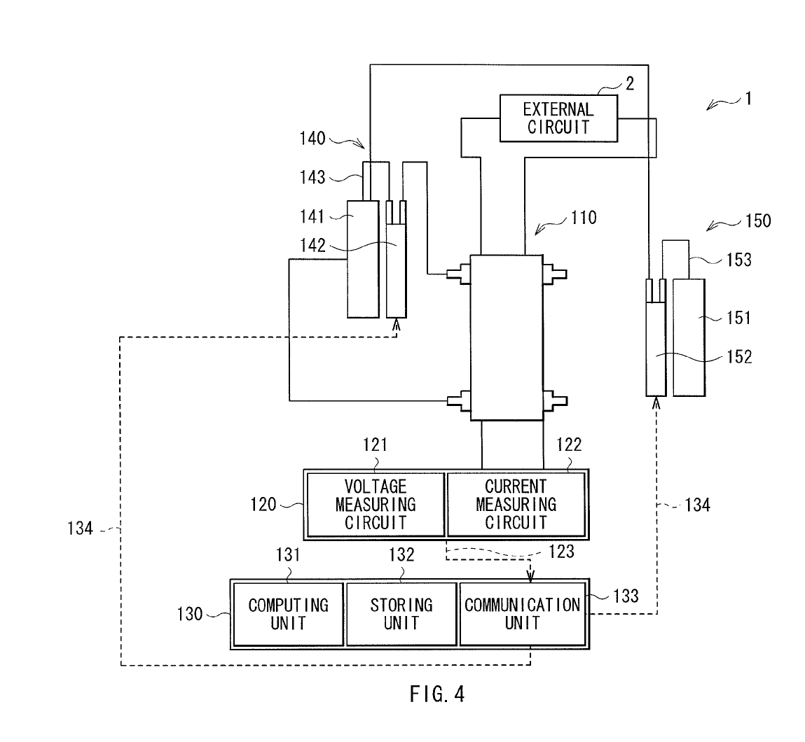

FIG. 4 illustrates a schematic configuration of an electronic device using the fuel cell unit 110. The electronic device is, for example, a mobile device such as a cellular phone or a PDA (Personal Digital Assistant) or an electronic device such as a notebook-type PC (Personal Computer) and has a fuel cell system 1 and an external circuit (load) 2 driven by electric energy generated by the fuel cell system 1.

The fuel cell system 1 has, for example, the fuel cell unit 110, a measuring unit 120 for measuring the operation condition of the fuel cell unit 110, and a control unit 130 for determining the operation condition of the fuel cell unit 110 on the basis of a measurement result of the measuring unit 120. The fuel cell system 1 also has a fuel/electrolyte supplying unit 140 for supplying the fluid F1 containing the fuel and the electrolyte to the fuel cell unit 110, and a fuel supplying unit 150 for supplying only fuel F2 such as methanol to a fuel/electrolyte storing unit 141. The fuel/electrolyte channel 30 in the fuel cell unit 110 is coupled to the fuel/electrolyte supplying unit 140 via the fuel/electrolyte inlet port 24A and the fuel/electrolyte outlet port 24B provided for the exterior member 24, and the fluid F1 is supplied from the fuel/electrolyte supplying unit 140.

The measuring unit 120 measures operation voltage and operation current of the fuel cell unit 110 and has, for example, a voltage measuring circuit 121 for measuring the operation voltage of the fuel cell unit 110, a current measuring circuit 122 for measuring the operation current, and a communication line 123 for sending the obtained measurement result to the control unit 130.

The control unit 130 controls fuel/electrolyte supply parameters and fuel supply parameters as the operation conditions of the fuel cell unit 110 on the basis of the measurement result of the measuring unit 120 and has, for example, a computing unit 131, a storing (memory) unit 132, a communication unit 133, and a communication line 134. The fuel/electrolyte supply parameters include, for example, supply flow velocity of the fluid F1 containing the fuel and the electrolyte. The fuel supply parameters may include, for example, the supply flow velocity and the supply amount of the fuel F2 and may include, as necessary, supply concentration. The control unit 130 is constructed by, for example, a microcomputer.

The computing unit 131 calculates an output of the fuel cell unit 110 from the measurement result obtained by the measuring unit 120 and sets the fuel/electrolyte supply parameters and the fuel supply parameters. Concretely, the computing unit 131 averages anode potentials, cathode potentials, output voltages and output currents sampled at predetermined intervals from various measurement results input to the storing unit 132 to calculate an average anode potential, an average cathode potential, an average output voltage, and an average output current, supplies them to the storing unit 132, compares the various average values stored in the storing unit 132 with one another, and determines the fuel/electrolyte supply parameter and the fuel supply parameter.

The storing unit 132 stores various measurement values sent from the measuring unit 120, various average values calculated by the computing unit 131, and the like.

The communication unit 133 has the function of receiving the measurement result from the measuring unit 120 via the communication line 123 and entering the result to the storing unit 132, and the function of outputting signals for setting the fuel/electrolyte supply parameter and the fuel supply parameter to the fuel/electrolyte supplying unit 140 and the fuel supplying unit 150 via the communication line 134.

The fuel/electrolyte supplying unit 140 has the fuel/electrolyte storing unit 141, a fuel/electrolyte supply adjusting unit 142, and a fuel/electrolyte supply line 143. The fuel/electrolyte storing unit 141 stores the fluid F1 and is, for example, a tank or a cartridge. The fuel/electrolyte supply adjusting unit 142 adjusts the supply flow velocity of the fluid F1. The fuel/electrolyte supply adjusting unit 142 is not limited as long as it is driven by a signal from the control unit 130 and is, preferably, a valve or an electronic pump driven by a motor or a piezoelectric device.

The fuel supplying unit 150 has a fuel storing unit 151, a fuel supply adjusting unit 152, and a fuel supply line 153. The fuel storing unit 151 stores only the fuel F2 such as methanol and is, for example, a tank or a cartridge. The fuel supply adjusting unit 152 adjusts the supply flow velocity and the supply amount of the fuel F2. The fuel supply adjusting unit 152 is not limited as long as it is driven by a signal from the control unit 130 and is, preferably, a valve or an electronic pump driven by a motor or a piezoelectric device. The fuel supplying unit 150 may have a concentration adjusting unit (not shown) for adjusting supply concentration of the fuel F2. The density adjusting unit may not be provided in the case of using pure methanol (99.9%) as the fuel F2, so that further miniaturization is possible.

In addition, the fuel cell system 1 may be manufactured as follows. For example, the fuel cell unit 110 is incorporated in a system having the measuring unit 120, the control unit 130, the fuel/electrolyte supplying unit 140, and the fuel supplying unit 150, each has the above-described structure. The fuel/electrolyte inlet port 14A and the fuel/electrolyte outlet port 14B and the fuel supplying unit 150 are connected via the fuel supply line 153 made by, for example, a silicone tube. The fuel/electrolyte inlet port 14A and the fuel/electrolyte outlet port 14B and the fuel/electrolyte supplying unit 140 are connected via the fuel/electrolyte supply line 143 made by, for example, a silicone tube. In such a manner, the fuel cell system 1 illustrated in FIG. 4 is completed.

In such a fuel cell system 1, when the fluid F1 containing the fuel and the electrolyte is supplied to the fuel cell unit 110 by the fuel/electrolyte supplying unit 140, as described above, power is taken out from the fuel cell unit 110 and the external circuit 2 is driven.

During operation of the fuel cell unit 110, the operation voltage and the operation current of the fuel cell unit 110 are measured by the measuring unit 120. On the basis of the measurement result, the fuel-electrolytic solution supply parameter and the fuel supply parameter are controlled by the control unit 130 as the operation conditions of the fuel cell unit 110. The measurement by the measuring unit 120 and the parameter control performed by the control unit 130 are frequently repeated, and the supply state of the fluid F1 and the fuel F2 is optimized so as to follow the characteristic fluctuations in the fuel cell unit 110.

Here, by including the fuel cell unit 110, the fuel cell system 1 realizes high output with a flexible, simple configuration in which a mobile device or even a large device can be incorporated. Therefore, the fuel cell system 1 may be suitably used, particularly, for a thin, power-consuming, multifunctional, high-performance electronic device.

### (Modification)

Next, a modification of the fuel cell unit of the embodiment will be described.

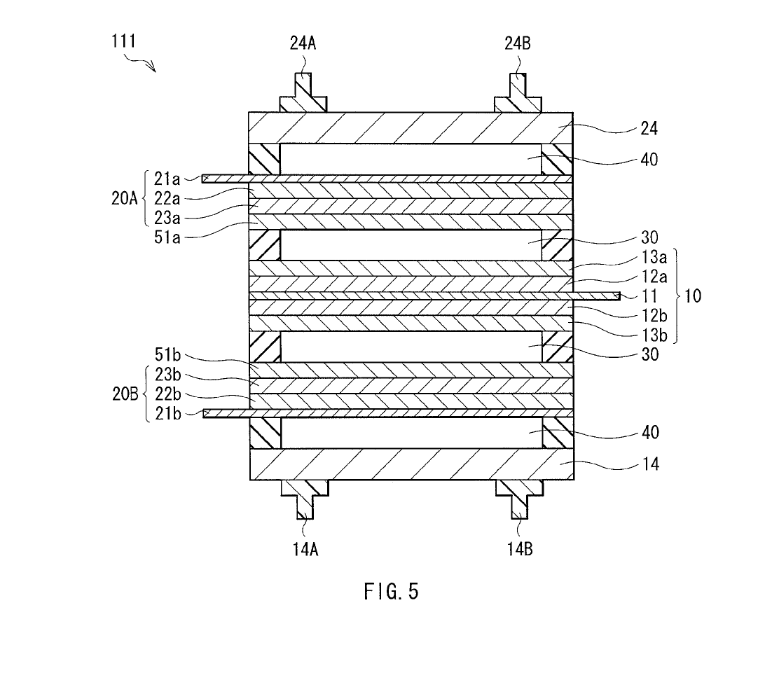

FIG. 5 illustrates a sectional structure of a fuel cell unit 111 as a modification of the fuel cell unit 110. The fuel cell unit 111 has a configuration similar to that of the fuel cell unit 110 except that functional layers 51a and 51b are provided on the side facing the fuel electrode 10 of the two oxygen electrodes 20A and 20B. Therefore, the same reference numerals are designated to the same components and their description will not be repeated.

The functional layers 51a and 51b have the function of preventing overvoltage (overvoltage suppression layer) which occurs in the oxygen electrodes 20A and 20B due to crossover of the fuel while maintaining ion paths between the fluid F1 containing the fuel and the electrolyte and the catalyst layers 23a and 23b and the function of suppressing flooding in the oxygen electrodes 20A and 20B (flooding suppression layer). In addition, the functional layers 51a and 51b also function as degradation preventing layers of suppressing degradation such as a crack or a hole in the oxygen electrodes 20A and 20B due to direct contact between the catalyst layers 23a and 23b and the fluid F1.

The function layers 51a and 51b are made of, for example, a porous material. By small holes in the porous material, the ion paths between the fluid F1 and the catalyst layers 23a and 23b are assured. Concrete examples of the porous material include a metal, carbon, a resin such as polyimide, and ceramics. The function layers 51a and 51b may be blend layers made of a plurality of materials in those materials. The resin may be a water-repellent resin or a hydrophilic resin. The thickness of the function layers 51a and 51b is, for example, about 1 μm to 100 μm. The thinner, the better. Further, the diameter of a small hole in the function layers 51a and 51b is, preferably, nanometers to micrometers but is not limited.

The function layers 51a and 51b may be made of an ion conductor such as a proton conductor. Examples of the proton conductor include a polyperfuluoroalkyl sulfonic acid-based resin (“Nafion” (registered trademark) made by DuPont), polystyrene sulfonate, a fullerene-based conductor, solid acid, and a resin having protonic conductivity.

Desirably, the function layers 51a and 51b are formed, for example, on the faces which are not thermocompression-bonded to the diffusion layers 22a and 22b, of the catalyst layers 23a and 23b by using, for example, bar coating for the reason that they can be coated with predetermined thickness. However, the method of forming the function layers 51a and 51b is not limited to the bar coating. Another coating method such as gravure coating, roll coating, spin coating, dip coating, doctor bar coating, wire bar coating, blade coating, curtain coating, or spray coating may be used. It is also possible to apply an application liquid containing the material of the function layers 51a and 51b on another member and dry it to form a porous film, and transfer the porous film onto the catalyst layers 23a and 23b. Further, the function layers 51a and 51b made of the above-described material may be thermocompression-bonded to the catalyst layers 23a and 23b.

As described above, the function layers 51a and 51b may be provided on the catalyst layers 23a and 23b of the oxygen electrodes 20A and 20B. With the configuration, effects similar to those of the fuel cell unit 110 are obtainable and fuel crossover to the oxygen electrodes 20A and 20B and the flooding state can be lessened or invalidated.

### Second Embodiment

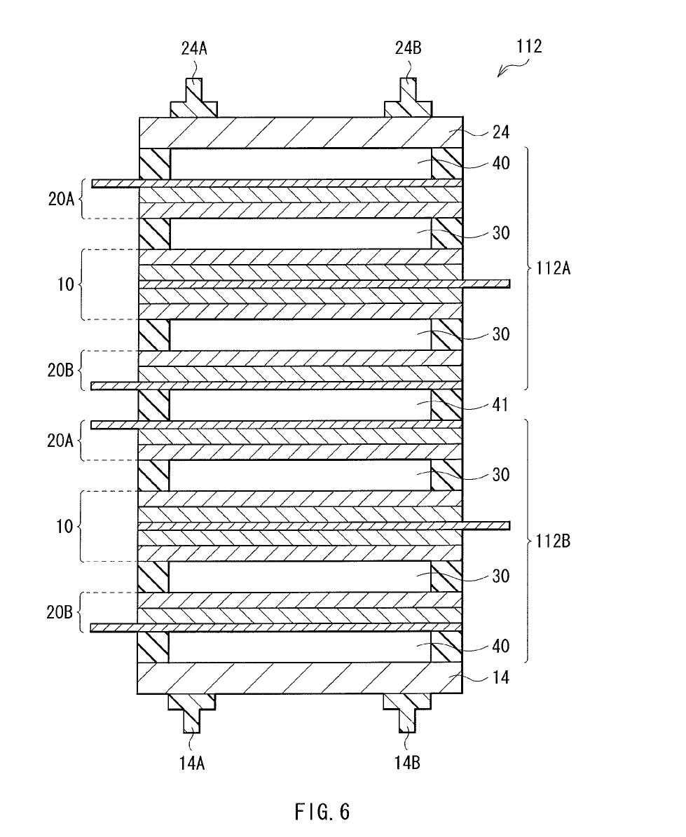

FIG. 6 illustrates a sectional structure of a fuel cell stack 112 according to a second embodiment. The same reference numerals are designated to the same components as those of the fuel cell unit 110 according to the first embodiment, and their description will not be repeated.

The fuel cell stack 112 has a structure that fuel cell units 112A and 112B are stacked in the vertical direction in the exterior members 14 and 24. Each of the fuel cell units 112A and 112B has the two oxygen electrodes 20A and 20B with the fuel electrode 10 therebetween. On both faces of each of the fuel electrodes 10, the fuel/electrolyte channels 30 are provided. In addition, the fuel/electrolyte channels 30 and the air channels 40 in each fuel cell unit and among the fuel cell units may be connected in series and/or in parallel, and may be a combination thereof.

The air channel 40 is provided on the side opposite to the fuel electrode 10 of each of the oxygen electrodes 20A and 20B in the fuel cell units 112A and 112B. However, a common air channel 41 is provided in a bonding part of the fuel cell units 112A and 112B. That is, the air channel between the oxygen electrode 20B in the fuel cell unit 112A and the oxygen electrode 20A in the fuel cell unit 112B is a channel common to the fuel cell units 112A and 112B.

As described above, a plurality of fuel cell units in each of which, as a unit, two oxygen electrodes are disposed for one fuel electrode 10 are stacked. In such a manner, while suppressing increase in the thickness due to stacking, a higher output can be realized. Further, at this time, by providing the common air channel 41 between the fuel cell units 112A and 112B which are adjacent by stacking to share a part of the air channel, it becomes advantageous for reduction in thickness.

In the embodiments, the configurations of the fuel electrode 10, the oxygen electrodes 20A and 20B, the fuel/electrolyte channel 30, and the air channel 40 have been concretely described above. However, the other structures or other materials may be employed. For example, the fuel/electrolyte channel 30 is not limited by the channel formed by processing the resin sheet as described in the foregoing embodiments but may be constructed by a porous sheet or the like.

Further, although the case of supplying a fluid obtained by mixing the fuel and the electrolyte to both side faces of the fuel electrode 10 via the fuel/electrolyte channels 30 has been described as an example in the foregoing embodiments, the invention is not limited to the case. For example, a fuel supply channel for flowing the fuel may be provided on the fuel electrode 10 side and an electrolyte solution channel for flowing an electrolyte solution may be provided on the oxygen electrodes 20A and 20B. Or, in this case, on the oxygen electrodes 20A and 20B side, not the channel for flowing the electrolyte solution but an electrolyte film having ion conductivity may be provided. Further, in this case, by making the function layers 51a and 51b described in the modification of the first embodiment of a material having ion conductivity, the function layers 51a and 51b may function as the electrolyte films. However, as described in the foregoing embodiments, increase in the thickness can be suppressed more effectively in the case of flowing the fuel and the electrolyte in the same channel.

Furthermore, the fluid F1 containing a fuel and an electrolyte described in the foregoing embodiment is not limited as long as it have proton (H+) conductivity and may be, for example, except for sulfuric acid, phosphoric acid and ionic liquid. Further, the fuel F2 described in the second embodiment is not limited to methanol but may be another alcohol such as ethanol or dimethyl ether or sugar fuel.

Furthermore, although the case of supplying air to the oxygen electrodes 20A and 20B has been described in the foregoing embodiments, oxygen or gas containing oxygen may be supplied in place of air.

Moreover, although the case of stacking the fuel cell units 112A and 112B in the vertical direction has been described in the second embodiment, the embodiment may be also applied to the case of constructing a fuel cell stack by stacking a plurality of fuel cell units in the lateral direction (the stack layer in-plane direction). In addition, although the configuration of stacking two fuel cell units has been described as an example, the number of units stacked may be three or more.

Moreover, although the configuration that the fuel cell system 1 used in an electronic device has the fuel cell unit 110 has been described in the first embodiment, the fuel cell system 1 may have the fuel cell stack 112 described in the second embodiment. With the configuration, an output becomes higher, and fuel cell system 1 can be suitably used for an electronic device whose power consumption is high.

In addition, the embodiments are not limited to the materials and thicknesses of the components described in the foregoing embodiment and the operation conditions of the fuel cell unit 110, but other materials, other thicknesses, and other operation conditions are also possible.

In addition, although the direct methanol fuel cell has been described as an example of the fuel in the foregoing embodiments, the embodiments are not limited to the direct methanol fuel cell and may be applied to a fuel cell using a substance other than liquid fuel such as hydrogen as the fuel, such as a polymer electrolyte fuel cell (PEFC), an alkali fuel cell, and an enzyme cell using a sugar fuel such as glucose.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-11. (canceled)

12. A fuel cell unit comprising:
a fuel electrode having two opposing faces;
first and second oxygen electrodes provided to face the both faces of the fuel electrode; and
an electrolyte layer provided between the fuel electrode and each of the first and second oxygen electrodes.

13. The fuel cell unit according to claim 12, wherein a channel for flowing a first fluid containing a fuel is provided on the side of the fuel electrode side of each of the first and second oxygen electrodes.

14. The fuel cell unit according to claim 13, wherein the first fluid contains a fuel and an electrolyte.

15. The fuel cell unit according to claim 12, wherein a channel for flowing a second fluid containing oxygen is provided on the side opposite to the fuel electrode, of each of the first and second oxygen electrodes.

16. The fuel cell unit according to claim 12, wherein a function layer is provided on the fuel electrode side of each of the first and second oxygen electrodes.

17. The fuel cell unit according to claim 16, wherein the function layer is made of a porous material.

18. The fuel cell unit according to claim 16, wherein the function layer is made of an ion conductor.

19. A fuel cell stack obtained by stacking a plurality of fuel cell units,
wherein each of the fuel cell units comprises:
a fuel electrode having two opposing faces;
first and second oxygen electrodes provided so as to face the both faces of the fuel electrode; and
an electrolyte layer provided between the fuel electrode and each of the first and second oxygen electrodes.

20. The fuel cell stack according to claim 19, wherein each of the fuel cell units comprises:
a first channel for flowing a first fluid containing a fuel, on the fuel electrode side of each of the first and second oxygen electrodes; and
a second channel for flowing a second fluid containing oxygen, on the side opposite to the fuel electrode, of each of the first and second oxygen electrodes.

21. The fuel cell stack according to claim 20, wherein the first or second oxygen electrode of one fuel cell unit and the first or second oxygen electrode of other fuel cell unit are connected so as to face each other, and the second channel is commonly used by the one fuel cell unit and the other fuel cell unit in the connection part.

22. An electronic device on which a fuel cell unit is mounted, wherein the fuel cell unit comprises:
a fuel electrode having two opposing faces;
first and second oxygen electrodes provided so as to face the both faces of the fuel electrode; and
an electrolyte layer provided between the fuel electrode and each of the first and second oxygen electrodes.
